(19) United States
(12) Patent Application Publication
(10) Pub. No.: US 2020/0130265 A1
(43) Pub. Date: Apr. 30, 2020

(54) SPHERICAL POLYMERIC PARTICLE CONTAINING GRAPHENE NANOPLATELETS AS THREE DIMENSIONAL PRINTING PRECURSOR

(71) Applicant: XG Sciences, Inc., Lansing, MI (US)

(72) Inventors: Leroy Magwood, JR., Lansing, MI (US); Bamidele Ali, Lansing, MI (US)

(21) Appl. No.: 16/668,564

(22) Filed: Oct. 30, 2019

Related U.S. Application Data
(60) Provisional application No. 62/752,470, filed on Oct. 30, 2018.

(51) Int. Cl. B29C 64/153; C08L 69/00; C08L 23/06; C08L 23/12; C08L 29/12; C08K 3/04

(52) U.S. Cl. CPC B29C 64/153; C08L 69/00; C08L 23/06; B33Y 10/00; C08L 29/12; C08K 3/042; C08L 23/12

(57) ABSTRACT

A processes and precursor are provided for use in selective laser sintering (SLS) that can create uniform packing densities that create good prints of 3D articles with a decrease in voids and incomplete infill. The resulting articles are electrically conductivity owing to a graphene coating thereby rendering such articles amenable to electroplating, or electrostatic coating processes. The process and precursor provide small diameter filled polymeric materials for 3D printing that are commercially viable to produce an article in a cost effective manner that has superior properties compared to conventional parts owing to reduced void volume and less residual inter-particle stress. The distribution of particles is spherical in shape and have a mean size polydispersity that varies by less than ±5% in diameter. As a result of the control of polydispersity, the particles have the attribute of spontaneously forming closed packed arrangements common to crystals.

### RELATED APPLICATIONS

This application claims priority benefit of U.S. Provisional Application Ser. No. 62/752,470 filed 30 Oct. 2018, the contents of which are hereby incorporated by reference.

### TECHNICAL FIELD

The present invention generally relates to the field of three dimensional printing, and more specifically to improved processes and materials for use in selective laser sintering

### BACKGROUND

Selective laser sintering (SLS) is an additive manufacturing technique that uses a laser as a power source to sinter powdered material to form a solid part. By aiming the laser automatically at points in space defined by a three dimensional (3D) model, the powdered material is sintered together to create a solid structure in a defined 3D shape. The laser selectively fuses powdered material by scanning cross-sections generated from a 3-D digital description of the part (for example from a computer aided design (CAD) file or scan data) on the surface of a powder bed. After each cross-section is scanned, the powder bed is lowered by one layer thickness, a new layer of material is applied on top, and the process is repeated until the part is completed.

The preparation of selective laser sintered (SLS) parts is complicated by the balance of conductive and convective cooling that occurs during the printing process. A common problem that occurs due to the inconsistent dispersion of materials and poor thermal gradients are the incomplete infill or voids present in printed materials. Voids from the incomplete infill are currently considered a material issue since the energy levels and thermal output from the laser are quickly approaching the machine limitations.

FIG. 1 is a scanning electron microscope (SEM) of an asymmetric polymeric composite material (aluminate) currently used in SLS polymeric 3D printing. Current products used for sintering in SLS are approximately 60 microns ±10 microns (filled particles are approximately 80-100 microns), are asymmetric, and are poor thermal conductors.

Recently, it has been determined that to increase the efficiency of printing and metal 3D printing in SLS that the use of spherical materials can create uniform packing densities that create good prints with a decrease in voids and incomplete infill. However, there are currently no available processes to make the use of spherical materials commercially viable.

Therefore, there is a need for improved processes and materials for use in selective laser sintering that can create uniform packing densities that create good prints of 3D parts with a decrease in voids and incomplete infill.

### SUMMARY

A powder material is provided for use in selective laser sintering. The powder material includes a plurality of particles having a size distribution, each of the particles having a polymeric matrix containing a loading of graphene nanoplatelets. The plurality of particles are spherical or tear drop have a mean size polydispersity that varies by less than ±20% and a diameter of between 2 to 200 microns. The polymeric matrix is formed of polyamide, polycarbonate, polystyrene, polyethylenes, polypropylenes, polyetherketones, polyetheretherketones, poly aryl ether ketones, and block copolymers in which any of the aforementioned polymers alone or in combination constitute more than 50% of polymer repeat units. The powder material has a loading of the graphene nanoplatelets that ranges from 0.001 to 50% volume percent, with a maximal linear extent in the three orthogonal X-Y-Z directions of between 3 and 50 nm, and secondary linear extent to at least 20 percent of the maximal linear extent. The powder material may further include a second type of particles that are sized to fit within interstitial spaces between contiguous particles of the plurality of particles.

A process of forming the aforementioned powder material is provided wherein the plurality of particles are produced by melt spraying; by mechanical separation or classification; or by microwave-atomized drying.

A process of forming an article with the aforementioned powder material includes exposing a powder material to selective laser sintering conditions, and allowing sufficient time under the selective laser sintering conditions to induce fusion between two contiguous particles of the powder material to form a fused mass. The process of article forming continues by repeating the exposing and allowing steps with positional variation to fuse additional particles to the fused mass to form the article.

### BRIEF DESCRIPTION OF THE DRAWINGS

The present invention is further detailed with respect to the following drawings that are intended to show certain aspects of the present of invention, but should not be construed as limit on the practice of the invention, wherein:

FIG. 1 is a scanning electron microscope (SEM) of a prior art asymmetric polymeric composite material (PA-12) currently used in selective laser sintered (SLS) polymeric 3D printing; and

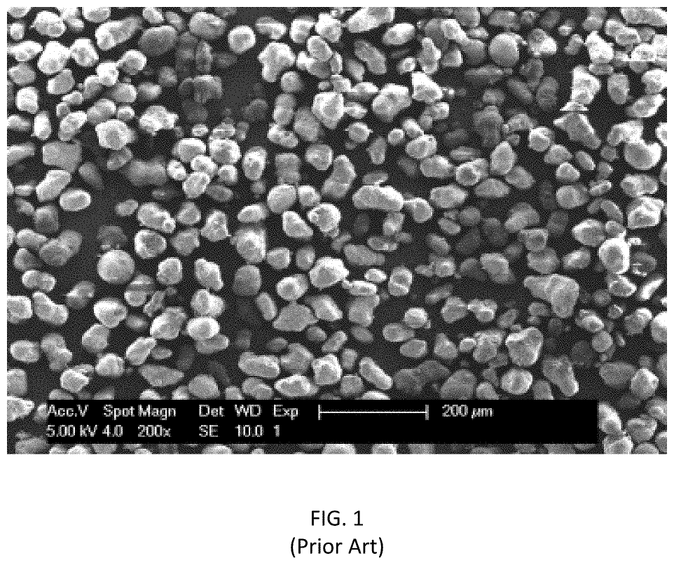

FIG. 2 is a schematic of an inventive particle tailored for usage as a 3D printing precursor.

### DETAILED DESCRIPTION

The present invention has utility as improved processes and precursor for use in selective laser sintering (SLS) that can create uniform packing densities that create good prints of 3D articles with a decrease in voids and incomplete infill. In some inventive embodiments, the resulting articles are electrically conductivity owing to the graphene coating thereby rendering such articles amenable to electroplating, or electrostatic coating processes. Embodiments of the invention provide small diameter filled polymeric materials for 3D printing that are commercially viable to produce an article in a cost effective manner that has superior properties compared to conventional parts owing to reduced void volume and less residual inter-particle stress. An inventive distribution of inventive particles is spherical in shape and have a mean size polydispersity that varies by less than ±5% in diameter. In some inventive embodiments, the mean size polydispersity that varies by between 0.1 and 3% in diameter. In some inventive embodiments, the plurality of particles have a mean size polydispersity that varies by between 0.1 and 5% in diameter. As a result of the control of polydispersity, inventive particles have the attribute of spontaneously forming closed packed arrangements common to crystals.

It is to be understood that in instances where a range of values are provided herein, that the range is intended to encompass not only the end point values of the range, but also intermediate values of the range as explicitly being included within the range and varying by the last significant figure of the range. By way of example, a recited range of from 1 to 4 is intended to include 1-2, 1-3, 2-4, 3-4, and 1-4.

Embodiments of the invention utilize sonication, melt spraying and microwave-atomized dried polymer to produce micron and sub-micron particles with a controlled spherical geometry that create an ideal printing system where the particle to particle distance is at a minimal threshold. Methods of formation of monodisperse polymer particles are known to the art. Kim, Shin-Hyun, et al. “Microwave-assisted self-organization of colloidal particles in confining aqueous droplets.” Journal of the American Chemical Society 128.33 (2006): 10897-10904; Wagner, Claudia S., Yan Lu, and Alexander Wittemann. “Preparation of submicrometer-sized clusters from polymer spheres using ultrasonication.” Langmuir 24.21 (2008): 12126-12128; and Kappler, P., et al. “Size and morphology of particles generated by spraying polymer-melts with carbon dioxide.” Sixth International Symposium on Supercritical Fluids: April 28-30 2003; Versailles. Institut National Polytechnique de Lorraine, 2003. In addition, control of the particle dispersity provides an added benefit to the process that allows for a better balance between melt-flow, conductive and convective processes that are occurring simultaneously during the print.

It is appreciated that the particle morphology is readily controlled as to a variety of properties including at one of mean size, shape, size distribution, surface texture, and chemical composition through conventional techniques. It is also appreciated that several stocks of particles can be mixed and used in SLS processes.

While spherical particles have certain advantages as to spontaneous space filling, other particle shapes are operative herein; the other particle shapes illustratively include ovoid, ellipsoidal, cylindrical, tetrahedral, trigonal pyramidal, cuboidal, and polygonal shaped having from 9 to 36 facets. In some inventive embodiments, the institial voids between closed packed spherical particles are filled by a second type of particle is provided that is sized to fill the interstitial void alone or in combination with other individual second type of particles. As a result, shrinkage of an article with full densification is reduced. It is further appreciated that the second type of particle can vary relative to the particles as to graphene content, including no loading; size, composition; shape; surface texture; or a combination thereof.

While a lack of size distribution, also referred to herein synonymously as monodisperse, afford certain advantages, particle size distributions are readily approximated by theoretical curves illustratively are Gaussian, Poisson, binomial, or a combination thereof. The mean size for such distributions is readily shifted.

Surface textures are readily varied from smooth to include a texture. A texture is readily imparted by etching through chemical, mechanical, or plasma techniques conventional to the art. Mechanical etching is readily accomplished by tumbling with abrasives or embossing.

The present invention incorporates graphene into the powdered sphere polymer precursor material. The inclusion of graphene provides an additional benefit during the printing process, as for most SLS systems in that during the printing stage/the entire bed of powdered material is heated to allow for better melt flow and to minimize the energy gap that the laser must overcome during the print process. Previously, the use of heating is often in vein as most polymers are poor at thermal conduction, so heating the print stage is not relevant after a few layers. However, the use of graphene in embodiments of the invention has demonstrated the ability to increase the thermal conductivity of polymers through conductive and resistive methods, and allows for a better range of heating at the bed and in the print area.

Graphene is a 1 to 10 atom-thick layer of sp² hybridized carbon atoms in a honeycomb-like, 2-dimensional sheet. Graphene is known to have excellent mechanical strength and flexibility, thermal and electric conductivities, and much higher optical cross section to laser light absorption relative to the polymer matrix forming the spherical particle. Graphene nanoplatelets have a maximal linear extent in the three orthogonal X-Y-Z directions of between 3 and 50 nm, and secondary linear extent to at least 20 percent of the maximal linear extent. In addition, the graphene has an aspect ratio between about 25 and 25,000 between the maximum linear extent and the minimum linear extent, synonymously referred to herein as thickness.

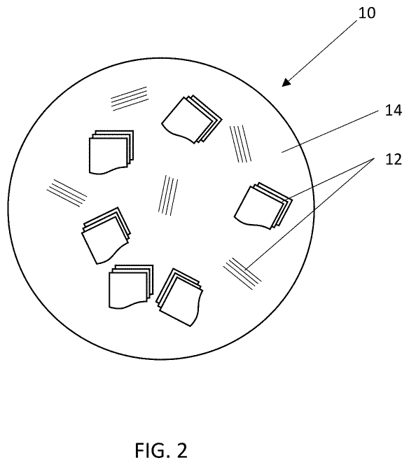

A schematic of an inventive particle is shown in cross section in FIG. 2 generally at 10. The particle 10 is composed of a polymer matrix 12 in which graphene nanoplatelets 14 are dispersed. The graphene nanoplatelets are not shown to scale for visual clarity and depicted to convey a distribution of orientations within the matrix 12. Polymers suitable to form a matrix 12 of a particle 10 illustratively include polyamide, polycarbonate, polystyrene, polyethylenes, polypropylenes, polyetherketones, polyetheretherketones, poly aryl ether ketones, and block copolymers in which any of the aforementioned polymers alone or in combination constitute more than 50% of the number of polymer repeat units of the resulting copolymer.

The diameter of a particle 10 is between 2 and 200 microns. The particle 10 in combination with other such particles has a polydispersity as detailed above. Loading of graphene nanoplatelets 12 in a matrix 14 range from 0.001 to 50 volume percent. In still other inventive embodiments, the graphene nanoplatelets 12 range from 0.001 to 50 volume percent of the particle 10.

Incorporation of the graphene into an inventive particle occurs, for example, by starting with polymerizable monomer, such as styrene is added to a polymerization inhibitor (antioxidant) and then mixed to obtain a monomer mixture. To the monomer mixture, 2% by weight of graphene nanoplatelets are added with mixing. The resulting mixture is used to form substantially monodisperse spheres according to a procedure of Wagner et al. above. There resulting particles are filtered and essentially monodisperse with a homogeneous loading of graphene therein. The resulting particles provide superior articles produced by SLS, as compared to using like size polystyrene lacking graphene content.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient roadmap for implementing the exemplary embodiment or exemplary embodiments. It should be understood that various changes may be made in the function and arrangement of elements without departing from the scope as set forth in the appended claims and the legal equivalents thereof.

1. A powder material for use in selective laser sintering comprising:
a plurality of particles having a size distribution, each of said particles having a polymeric matrix containing a loading of graphene nanoplatelets.

2. The powder material of claim 1 wherein said plurality of particles are spherical or tear drop have a mean size polydispersity that varies by less than ±20% and a diameter of between 2 to 200 microns.

3. The powder material of claim 1 wherein said plurality of particles have a mean size polydispersity that varies by between 0.1 and 5% in diameter

4. The powder material of claim 1 wherein said polymeric matrix is formed of: polyamide, polycarbonate, polystyrene, polyethylenes, polypropylenes, polyetherketones, polyetheretherketones, poly aryl ether ketones, and block copolymers in which any of the aforementioned polymers alone or in combination constitute more than 50% of polymer repeat units.

5. The powder material of claim 1 wherein the loading of said graphene nanoplatelets range from 0.001 to 50% volume percent.

6. The powder material of claim 1 wherein the loading of said graphene nanoplatelets have a maximal linear extent in the three orthogonal X-Y-Z directions of between 3 and 50 nm, and secondary linear extent to at least 20 percent of the maximal linear extent.

7. The powder material of claim 1 further comprising a second type of particles that are sized to fit within interstitial spaces between contiguous particles of said plurality of particles.

8. A process of forming the powder material of claim 1 wherein said plurality of particles are produced by melt spraying.

9. A process of forming the powder material of claim 1 wherein said plurality of particles are produced by mechanical separation or classification.

10. A process of forming the powder material of claim 1 wherein said plurality of spherical particles are produced by microwave-atomized drying.

11. A process of forming an article comprising:
exposing the powder material of claim 1 to selective laser sintering conditions;
allowing sufficient time under the selective laser sintering conditions to induce fusion between two contiguous particles of said powder material to form a fused mass;
repeating the exposing and allowing steps with positional variation to fuse additional particles to the fused mass to form the article.
